(19) United States
(12) Patent Application Publication
(10) Pub. No.: US 2024/0155197 A1
(43) Pub. Date: May 9, 2024

(54) DEVICE AND METHOD FOR QUESTION ANSWERING

(71) Applicant: InterDigital CE Patent Holdings, SAS, Paris (FR)

(72) Inventors: Deniz Engin, Rennes (FR); Yannis Avrithis, Vrilissia (GR); Quang Khanh Ngoc Duong, Rennes (FR); Francois Schnitzler, Saint Ave (FR)

(21) Appl. No.: 18/280,746

(22) PCT Filed: Mar. 8, 2022
(86) PCT No.: PCT/EP2022/055817

§ 371 Date: Sep. 7, 2023

(30) Foreign Application Priority Data
Mar. 10, 2021 (EP) 21305290.5

(51) Int. Cl. H04N 21/475; H04N 21/8549

(52) U.S. Cl. CPC H04N 21/4758; H04N 21/8549

(57) ABSTRACT

A device receives a question, which can be related to an event, from a user through a user interface, and at least one hardware processor generates a first summary of at least one dialogue of the event; and output a result obtained by processing the summary, the question and possible answers to the question.

### TECHNICAL FIELD

The present disclosure relates generally to Artificial Intelligence and in particular to question answering.

### BACKGROUND

This section is intended to introduce the reader to various aspects of art, which may be related to various aspects of the present disclosure that are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

There is a growing demand for a seamless interface for communication with consumer electronics (CE) devices, for example smart home devices such as Amazon Echo, Google Home, and Facebook Postal that have become important parts of many homes, for instance as personal assistants.

However, conventional solutions mostly make use of microphone to listen to user commands (thanks to automatic speech recognition) in order to help out with things like accessing media, managing simple tasks, and planning the day ahead.

As a starting point for the living assistance, visual question answering (VQA) [see e.g. Aishwarya Agrawal, “VQA: Visual Question Answering,” 2016, arXiv:1505.00468v7, and Yash Goyal et al., “Making the V in VQA Matter: Elevating the Role of Image Understanding in Visual Question Answering,” 2017, arXiv:1612.00837v3] and visual dialog [see e.g. A. Das et al., “Visual dialog,” Proc. CVPR, 2017], which require an Artificial Intelligence (μl) system to have a meaningful dialog with humans in conversational language about visual content, have received recent attention by the research community.

Given an input image and a natural language question about the image, the task of the VQA system is to provide an accurate natural language answer. As an example, with the input of an image of a woman holding up two bananas as a mustache and the question what the mustache is made of, the VQA system can output the answer ‘bananas’.

Moving towards video, in “Heterogeneous Memory Enhanced Multimodal Attention Model for Video Question Answering,” https://arxiv.org/pdf/1904.04357v1.pdf, Fan et al. proposed an end-to-end trainable Video Question Answering (VideoQA) framework with three major components: a heterogeneous memory that can learn global context information from appearance and motion features, a question memory that helps understand the complex semantics of question and highlights queried subjects, and a multimodal fusion layer that performs multi-step reasoning to predict the answer.

Garcia and Nakashima [“Knowledge-Based Video Question Answering with Unsupervised Scene Descriptions,” 2020, https://arxiv.org/pdf/2007.08751.pdf] presented a solution targeting movie data bases that computes an answer by fusing answer scores computed from different modalities: current scene dialogues, generated video scene descriptions, and external knowledge—plot summary—generated by human experts.

As home environments or streamed media content can be sensed via multiple sources of information (e.g. audio, visual, text) for an extended duration in time, future smart home systems (such as smart TV) are expected additionally to exploit such knowledge built from dialog comprehension, scene reasoning, and storyline knowledge extracted from audio and visual sensors to offer better services.

However there is currently no solution to generate such storyline knowledge automatically and to exploit it to answer questions. It will thus be appreciated that there is a desire for a solution that addresses at least some of the shortcomings of answer systems. The present principles provide such a solution.

### SUMMARY OF DISCLOSURE

In a first aspect, the present principles are directed to a device comprising a user interface configured to receive a question about an event from a user and at least one hardware processor configured to generate a first summary of at least one dialogue of the event and output a result obtained by processing the summary, the question and possible answers to the question.

In a second aspect, the present principles are directed to a method that includes receiving, through a user interface, a question about an event from a user, generating, by at least one hardware processor, a first summary of at least one dialogue of the event and outputting, by the at least one hardware processor, a result, the result obtained by processing the summary, the question and possible answers to the question.

In a third aspect, the present principles are directed to a computer program product which is stored on a non-transitory computer readable medium and includes program code instructions executable by a processor for implementing the steps of a method according to any embodiment of the second aspect.

### BRIEF DESCRIPTION OF DRAWINGS

Features of the present principles will now be described, by way of non-limiting example, with reference to the accompanying drawings, in which:

FIG. 1 illustrates a device for answer generation according to an embodiment of the present principles;

FIG. 2 illustrates a system for answer generation to a question according to an embodiment of the present principles;

FIG. 3 illustrates an answer candidate generation module according to the present principles;

FIG. 4 illustrates a multimodal visual question answering system according to an embodiment of the present principles;

FIG. 5 illustrates a home assistant system according to an embodiment of the present principles; and

FIG. 6 illustrates various ways of generating the knowledge summary according to embodiments of the present principles.

### DESCRIPTION OF EMBODIMENTS

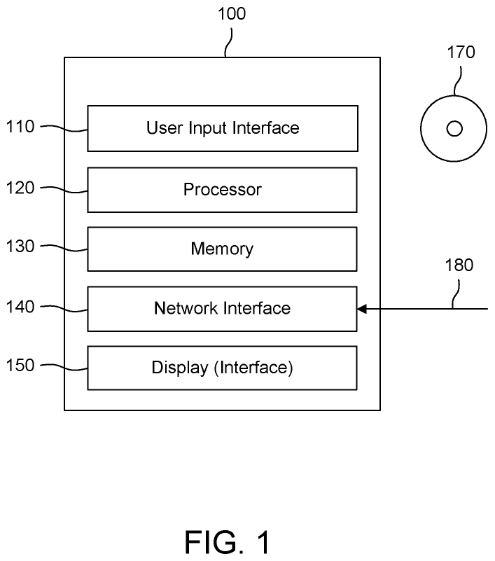

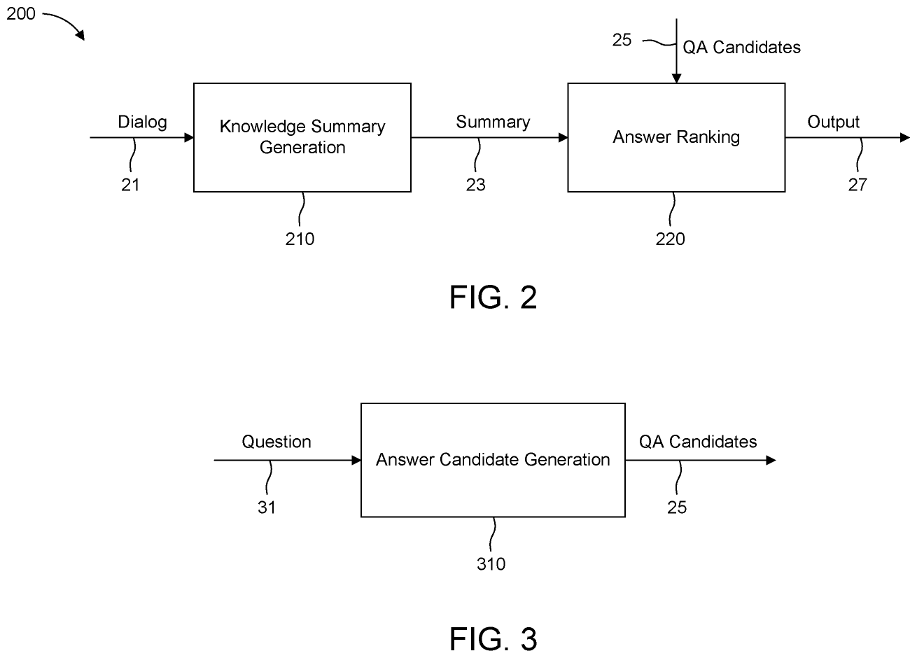

FIG. 1 illustrates a device 100 for answer generation according to an embodiment of the present principles. The device 100 typically includes a user input interface 110, at least one hardware processor (“processor”) 120, memory 130, and a network interface 140. The device 100 can further include a display interface or a display 150. A non-transitory storage medium 170 stores computer-readable instructions that, when executed by a processor, perform the method described with reference to any of the methods described in FIGS. 2-6.

The user input interface 110, which for example can be implemented as a microphone, a keyboard, a mouse, a touch screen or a combination of two or more input possibilities, is configured to receive input from a user. The processor 120 is configured to execute program code instructions to perform a method according to at least one method of the present principles. The memory 130, which can be at least partly non-transitory, is configured to store the program code instructions to be executed by the processor 120, parameters, image data, intermediate results and so on. The network interface 140 is configured for communication with external devices (not shown) over any suitable connection 180, wired or wireless.

Answering a question about an event can require analysis or memory of the past. The present principles proposes to generate a summary of the past and then to use the summary to rank answers to a question.

FIG. 2 illustrates a system 200 for such answer generation to a question according to an embodiment of the present principles. FIG. 2 (as well as FIGS. 3-6) can also be read as a description of the corresponding method. The system can be implemented in the processor 120 and will be described using functional modules. A Knowledge summary generation module 210 takes as input dialog 21, e.g. of a scene or event, and generates a summary 23. An Answer ranking module 220 processes the summary 23 and the question and possible answers 25, “QA candidates,” to generate an output 27. The output can for example be a selected answer among the possible answers or a ranking of the possible answers (e.g. according to determined relevance). As in all embodiments, the output is typically intended for the user and can be conveyed to the user directly, in particular in case of a selected answer, or via a further device.

The Knowledge summary generation module 210 is configured to transform a dialog (or a transcript of the dialog) into a meaningful summary of events in the dialog. There are conventional solutions that can be used to implement the Knowledge summary generation module 210. For example, Chen et al. [see Jiaao Chen and Diyi Yang, “Multi-View Sequence-to-Sequence Models with Conversational Structure for Abstractive Dialogue Summarization,” 2020 https://arxiv.org/pdf/2010.01672.pdf] uses machine learning models such as sequence-BERT, BART, C99 or HMMs to extract topics, dialog phases, to encode the sentences and to write a summary. Other methods could be used, such as an algorithm manually written by an expert, random word selection or other trained machine learning (ML) models including other neural network architectures such as recurrent neural networks, convolutional networks or other feed-forward networks.

The Answer ranking module 220 is configured to take as input the summary 23 output by the Knowledge summary generation module 210 and QA candidates 25 to match the answers and question to output an output 27. The output 27 can for example be the best answer (e.g. the most likely answer according to some determination method) or an answer ranking. The Answer ranking module 220 can for example be implemented by transformers (which will be described hereinafter), a type of ML model widely used in natural language processing recently, combined with a additional neural layers (or other models) to compute the score or to select one answer. Other implementation options include ML models such as decision trees, support vector machines, linear or logistics regression, neural networks including recurrent neural networks, convolutional networks, feed-forward networks, and their combination, an algorithm written by an expert or a word matching algorithm.

A transformer is a deep neural network with several self-attention layers. It is a sequence-to-sequence modelling architecture used in many natural language processing tasks. Existing transformer architectures, which take the summary and the QA candidates as inputs can be used in the system according to the present principels. It is noted that a common pre-processing in natural language processing, for example tokenization, can be needed to transform the raw input texts into meaningful vector, matrix, or tensor representations for a transformer.

QA candidates 25 is one of the inputs to the system 200 according to the present principles. In many practical applications, a human user would ask a question without providing candidate answers. The system 200 can thus include a module to generate candidate answers. FIG. 3 illustrates an Answer candidate generation module 310 according to the present principles. The input question 31 can for example be provided directly in text form but it can also be generated from an audio recording using conventional speech-to-text technology. The Answer candidate generation module 310 takes the question as input and outputs both the question and a set of candidates answers, i.e. QA candidates 25 (which is seen as input to the Answer ranking module in FIG. 2). Yang et al. [see Antoine Yang, Antoine Miech, Josef Sivic, Ivan Laptev and Cordelia Schmid, “Just Ask: Learning to Answer Questions from Millions of Narrated Videos”, 2020, https://arxiv.org/pdf/2012.00451.pdf] describe a system to generate a set of possible answers from a video using speech-to-text, recurrent neural networks and a transformer model, but it will be understood that other implementations could be used, such as for example neural networks, decision trees, and an algorithm written by an expert.

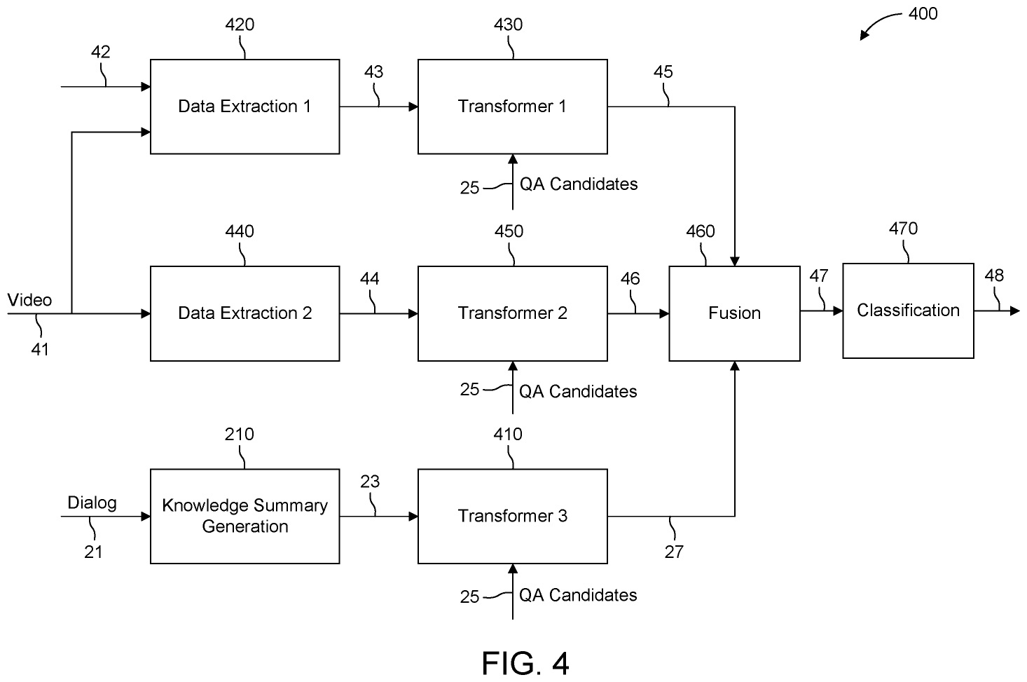

FIG. 4 illustrates a multimodal visual question answering system 400 according to an embodiment of the present principles, obtained by expanding the question answering system 200 illustrated in FIG. 2.

The system included three branches. The lower branch is similar to the system 200 of FIG. 2, the difference being that the answer ranking system has been replaced by Transformer 3 410, which functions as the Answer ranking module 220.

The middle branch takes video 41 as input to Data extraction module 2 440 that generates a video summary 44 that is input to Transformer 2 450, while the upper branch takes the video 41 and possibly external information 42 as input to Data extraction module 420 that generates a summary 43 that is input to Transformer 1 430.

Each transformer further takes the QA candidates 25 as input.

Typically, the upper and middle branches process the input and the QA candidates in a manner similar to the lower branch to obtain a score for the answers, a vector of feature for each answer or a global representation such as a vector, a matrix or a tensor. It will be understood that the branches can process different types of input and that their number can vay; for illustration purposes, Error! Reference source not found.4 includes three branches, i.e. two branches in addition to the lower branch.

In more detail, the middle branch first uses a data extraction module 440 to compute features 44 from the video 41. The data extraction module 440 can be similar to the Knowledge summary generation module 210 and can be implemented in a similar or in a different manner; typically, it would be a trained ML model or an algorithm written by an expert. Features 44 computed could for example be a high-level scene description, containing the name of the objects in the scene and their relationships (next to, on top of, within . . . ); name of objects and bounding boxes of these object in each picture; shape outline of the characters; skeleton of the characters or animals; activities humans are performing; a combination of any of the above; any of the above for each frame, sequence of frames or the whole video, etc. The features 44 are then be combined in a transformer 450 with the QA candidates 25 in a manner similar to the Answer ranking module 220

The top branch illustrates a possible use of external information in addition to the video. In this example, the video 41 and the external information 42 are used as input to a first data extraction module 420. External information could for example include data from additional sensors (e.g. contact sensors, pressure plates, thermometers, . . . ), a map of a location, logs, text files (e.g. news report, Wikipedia article, books, technical documents . . . ), etc. Data extraction module 1 420 processes the inputs and generates features 43 in a manner similar to for example the second data extraction module 440; the first data extraction module can be of the same nature as or of a different nature than the second data extraction module 440; typically it would be a ML model or an algorithm written by an expert. The features 43 can then be combined in a first transformer 430 with the QA candidates 25, similar to the workings of Transformers 2 and 3.

It should be understood that the solution of the present principles can be combined with other processing schemes. The architecture of a branch is not limited to what is described here or to two blocks. For example, features from multiple branches could be aggregated at any point and further processed, attention mechanisms might turn off certain parts of the input, additional pre-processing could be performed, external information could be used at any point, etc. Any number of branches may also be considered.

Fusion module 460 combines the outputs 45, 46, 27 of the branches using a fusion mechanism to generate a fused output 47. The fusion mechanism can be fusion with modality attention mechanism, described hereinafter, but other fusion mechanisms can also be used, such as max-pooling, softmax, averaging functions, etc. The fusion module 460 can also be a deep learning model, in particular in case the inputs are feature vectors for each answer or global feature vectors.

Fusion with modality attention relies on a branch attention mechanism. In this case, the fusion module 460 is typically a deep learning model and may take as additional inputs the QA candidates 25 or only the question. Internally, such a mechanism uses the branch features, possibly with the QA candidates, to compute a weight for each input branch. As an example, the weight could be computed using an attention mechanism, for example two linear layers (a linear combination of the inputs plus a constant) and a softmax layer. The weight is used to modify the features of the branches, for example by multiplying the features by this weight. These weighted features can then be used to compute a score for each answer, for example by using a linear layer.

Classification module 470 takes as input the fused output 47 and generates a result 48. The result 48 can be obtained by selecting the best answer (e.g. the one with the highest score or the like). If the fused output 47 is a vector of scores, determining the result 48 can be obtained using an argmax function. Otherwise, the classification module 470 can be any suitable algorithm, including one written by an expert or any type of machine learning model such as decision tree, support vector machine or a deep learning model.

The systems of the present principles can be trained end-to-end with all branches in a supervised way given training data consisting of input-output pairs. Any suitable conventional training technique—e.g. choice of hyperparameters such as losses, optimizers, batch size, . . . —can be adapted and used. A classification loss such as the cross-entropy loss can be used to optimize the network parameters. Typically, for deep learning models, training relies on some form of stochastic gradient descent and backpropagation.

It is also possible to train each branch separately and then to keep the parameters of each branch fixed or partially fixed and to train only the fusion mechanism and subsequent elements. This is trivial when the output of a branch is a score for each answer: a simple classifier such as one selecting the answer with the highest score can be added. In case the output of a branch is not a score for each answer, a more complex classifier (such as some neural network layers) can be used to select a single answer.

Once the system is trained, given the input, the system will be able to compute an output answer automatically.

The system according to the present principles can be used in a home assistant to address question answering in for example a home environment in the form of knowledge-based multiple-choice tasks. In this context, the input can be: a question from user, N possible candidate answers assumed to be known in advance, automatically generated or set by the user, a video scene recorded at home by a camera, and an audio recording corresponding to the video scene. The output is the predicted answer. As an option, the system can access external resources to retrieve contextual information (such as what happened before at home, what often happens, names and habits of people in the house, etc). An example could be a user asking the home assistant “where is my mobile phone?”. Intuitively, information from the camera can show the correct answer is “The phone is on the table”.

It will be understood that a vocal command or question can be converted to text by a conventional speech-to-text method (i.e. Automatic Speech Recognition, ASR), that the text can be processed to determine the command or question that can be used to determine QA candidates 25.

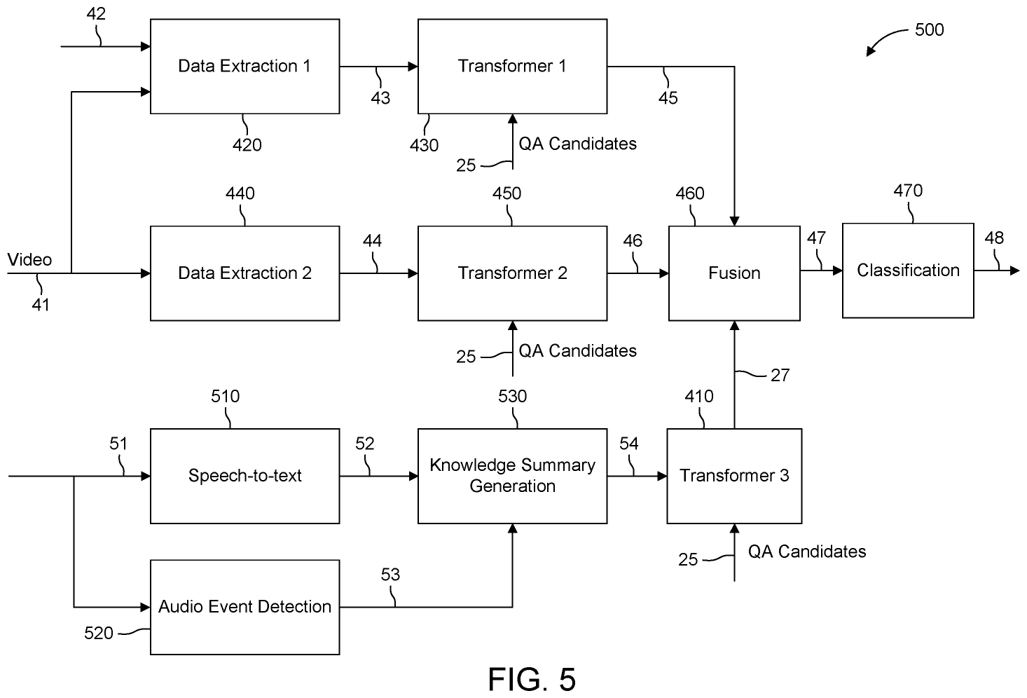

FIG. 5 illustrates a home assistant system 500 according to an embodiment of the present principles. The system 500 is similar to system 400 illustrated in FIG. 4; essentially, only the differences will be described. It is noted that for example the top branch is optional in case information such as a description of the home is included in the system 500, for example provided in advance by the home owner or learned.

Input to the lower branch is an audio sample 51, typically a recording. A speech-to-text module 510 takes the audio sample and outputs corresponding text 52, as is well known. An audio event detection module 520 processes the audio sample 51 to detect events via audio sensors along time, as is well known. Examples of audio event output 53 include detected sounds of different key events or equipment such as for example the sound of water falling, the noise of a coffee machine, the crash of glass breaking, the crying of a baby, and so on.

The Knowledge summary generation module 530 combines (in time order) the text 52 with the audio event output 53 to generate a summary 54 that is provided to the third transformer 410.

The VQA system according to the present principles can be used in a smart TV assistant to provide the ability to answer audience questions about a current video or recently rendered videos. For example, someone leaving the room e.g. to answer a phone call can come back and ask questions to get back into the current show. It could also be used by someone who missed a previous episode of a TV series.

The smart TV assistant can be triggered using various methods including keyword activation, pressing a button on a remote or monitoring the room for a question related to a video. The smart TV assistant can be implemented as the system illustrated in FIG. 4, with QA candidates generated using for example the described way of converting speech to QA candidates.

The lower branch generates a knowledge summary by processing a dialog (as will be further described), the summary is processed together with the QA candidates by e.g. a transformer to generate a set of features. The features can for example be a vector for each answer, a score for each answer or a single vector, array or tensor. In parallel, although not required, other branches can also generate other features for the answers, for example by generating a scene description and/or by using external information. The different features are fused using an attention mechanism or any other fusion method such as max-pooling, softmax, various averaging functions etc. after which a classifier can be used to select the best answer that, in case the fused features is a vector of score, can be as simple as an argmax function.

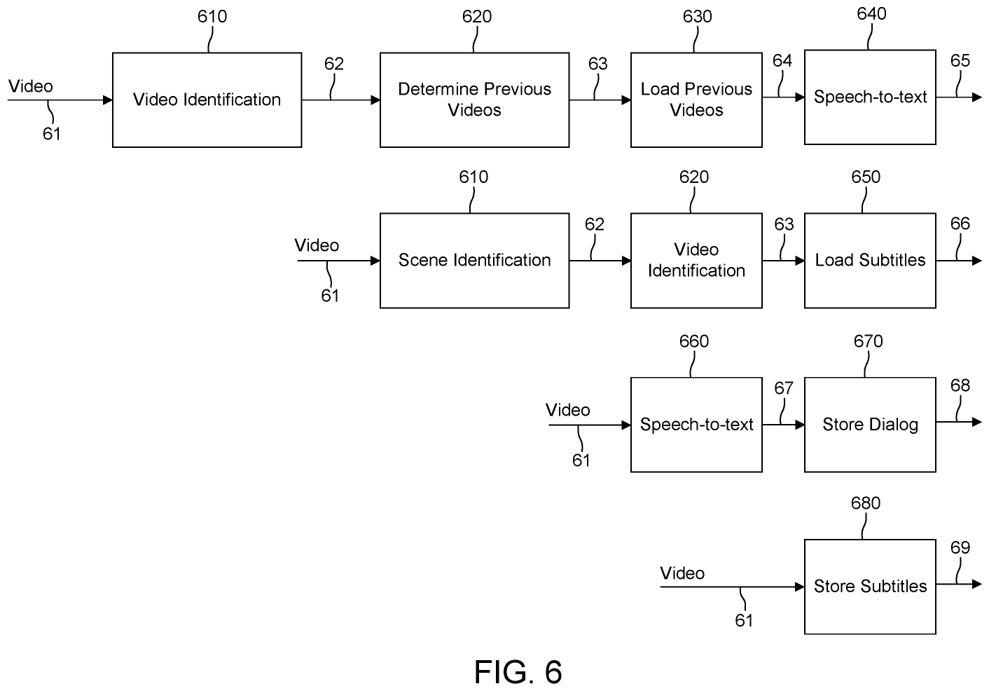

FIG. 6 illustrates various ways of obtaining the dialog used to generate the knowledge summary according to embodiments of the present principles.

In the first pipeline, the (current) video 61 is identified using scene identification 610 (for example by matching images to a database or by using the title of the video or any other metadata) to obtain a video identifier 62 that is used by a module 620 to determine (e.g. by database look-up) previous videos 63 that are loaded by module 630 to obtain the previous videos, which are input to a speech-to-text module 640 that converts the dialog to dialog text 65. These steps can be partially or completely offloaded to another device, such as an edge node or to the cloud.

In the second pipeline, the previous videos are identified as in the first pipeline and a module 650 obtains (e.g. by extraction from the videos or from a database) the corresponding subtitles that are then output as the dialog 66.

In the third pipeline, the video 61 displayed is continuously processed by an off-the-shelf speech-to-text module 660 and the generated dialog 67 is stored by a dialog storage module 670 to be output as the dialog 68 when necessary. The size of the stored dialog can be limited to e.g. a few hours.

In the fourth pipeline, a subtitle storage module 680 directly stores the subtitles that can be provided as the dialog 69.

Different pipelines may be combined. For example, the third and fourth pipelines could be used together to store dialog, the fourth when subtitles are available, the third when they are not. The smart TV assistant could also select a different pipeline based on the question. For example, the smart TV assistant may select the third pipeline for the question “What happened when I was gone?” and the first for the question: “I missed the episode yesterday. What happened?” This selection could for example be based on the presence of certain keywords or could rely on machine learning.

### EVALUATION

The solutions of the present principles were evaluated on the KnowIT VQA dataset, composed of 24,282 human-generated questions for 12,087 video clips, each with a duration of 20 seconds. The clips were extracted from 207 episodes of a TV show. The dataset contained knowledge-based questions that require reasoning based on the content of a whole episode or season, which is different from other video question answering datasets. Four different types of questions are defined as visual-based (22%), textual-based (12%), temporal-based (4%), and knowledge-based (62%) in the dataset. Question types are provided only for the test set.

The VQA mechanism according to embodiments of the present principles is compared to other VQA methods, “Garcia 2020,” without using fusion; the results are displayed in Table 1, where the numbers correspond to the accuracy for questions. “Read”, “Observe” and “Recall” denote existing branches. For the present solution, the result of two versions of the “recall” branch are presented, as are two embodiments of the proposed solution: “Scene Dialogue Summary” where the dialogue used to generate the summary is from the current scene only, and “Episode Dialogue Summary” where the dialogue used to generate the summary is from a whole episode. The two versions differ by an internal mechanism used to aggregate scores computed on subwindow of the text: the first one takes the maximum of the score over all subwindows, the second (soft-softmax) combines all scores into one using softmax functions. Two versions of “Episode Dialogue Summary” are presented. As can be seen, “Episode Dialogue Summary—Soft-Softmax” outperforms other methods. In particular, it outperforms “Recall” that uses human-written knowledge instead of an automatically generated summary.

| | Branch training | Visual | Text | Temp. | Know. | All |
|---|---|---|---|---|---|---|
| Garcia | Read | 0.656 | 0.772 | 0.570 | 0.525 | 0.584 |
| 2020 | Observe | 0.629 | 0.424 | 0.558 | 0.514 | 0.530 |
| | Recall | 0.624 | 0.620 | 0.570 | 0.725 | 0.685 |
| Proposed | Read | 0.649 | 0.801 | 0.581 | 0.543 | 0.598 |
| solution | Observe | 0.625 | 0.431 | 0.512 | 0.541 | 0.546 |
| | Recall | 0.629 | 0.569 | 0.605 | 0.706 | 0.669 |
| | Recall-Soft- | 0.680 | 0.623 | 0.663 | 0.709 | 0.691 |
| | Softmax | | | | | |
| | Scene Dialogue | 0.631 | 0.746 | 0.605 | 0.537 | 0.585 |
| | Summary | | | | | |
| | Episode Dialogue | 0.633 | 0.659 | 0.686 | 0.720 | 0.693 |
| | Summary | | | | | |
| | Episode Dialogue | 0.680 | 0.725 | 0.791 | 0.745 | 0.730 |
| | Summary - Soft- | | | | | |
| | Softmax | | | | | |

Table 2 illustrate results of novice humans, “Rookies,” expert humans, “Masters,” that are familiar with the TV show in question, different MQA systems and an embodiment of the present principles that uses fusing multiple branches.

| Method | Visual | Text | Temp. | Know. | All |
|---|---|---|---|---|---|
| Rookies | 0.936 | 0.932 | 0.624 | 0.655 | 0.748 |
| Masters | 0.961 | 0.936 | 0.857 | 0.867 | 0.896 |
| TVQA | 0.612 | 0.645 | 0.547 | 0.466 | 0.522 |
| ROCK-facial | 0.654 | 0.688 | 0.628 | 0.646 | 0.652 |
| ROCK-GT | 0.747 | 0.819 | 0.756 | 0.708 | 0.731 |
| ROLL-human | 0.708 | 0.754 | 0.570 | 0.567 | 0.620 |
| ROLL | 0.718 | 0.739 | 0.640 | 0.713 | 0.715 |
| Present solution | 0.770 | 0.764 | 0.802 | 0.752 | 0.759 |

As can be seen, the present solution outperforms every system, except ROCK-GT when it comes to Text. The present solution also outperforms Rookies in several aspects.

As will be appreciated, the present embodiments can improve question answering systems.

It should be understood that the elements shown in the figures may be implemented in various forms of hardware, software or combinations thereof. Preferably, these elements are implemented in a combination of hardware and software on one or more appropriately programmed general-purpose devices, which may include a processor, memory and input/output interfaces.

The present description illustrates the principles of the present disclosure. It will thus be appreciated that those skilled in the art will be able to devise various arrangements that, although not explicitly described or shown herein, embody the principles of the disclosure and are included within its scope.

All examples and conditional language recited herein are intended for educational purposes to aid the reader in understanding the principles of the disclosure and the concepts contributed by the inventor to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the principles of the disclosure. Similarly, it will be appreciated that any flow charts, flow diagrams, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, read only memory (ROM) for storing software, random access memory (RAM), and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The disclosure as defined by such claims resides in the fact that the functionalities provided by the various recited means are combined and brought together in the manner which the claims call for. It is thus regarded that any means that can provide those functionalities are equivalent to those shown herein.

1. A device comprising:
a user interface configured to receive, from a user, a question about an event in at least one video scene; and
at least one hardware processor configured to:
generate a first summary of at least one dialogue of the at least one video scene; and
output a first result obtained by processing the first summary, the question and possible answers to the question.

2. The device of claim 1, wherein the processing is performed using a transformer.

3. The device of claim 1, wherein the first result is a score for each possible answer or the possible answer with the highest score.

4. The device of claim 1, wherein the at least one hardware processor is further configured to:
generate a second summary of video information related to the at least one video scene;
process the second summary, the question and the possible answers to the question to obtain a second result; and
output a final result obtained by processing the first result and the second result.

5. The device of claim 4, wherein the at least one hardware processor is configured to process the first result and the second result using a fusion mechanism.

6. The device of claim 5, wherein the fusion mechanism is a modality attention mechanism that weights the first result and the second result.

7. The device of claim 1, wherein the dialogue obtained from at least one video or through capture using a microphone and an audio-to-text function.

8. The device of claim 1, wherein the device is one of a home assistant and a TV.

9. (canceled)

10. A method comprising:
receiving, from a user through a user interface, a question about an event in at least one video scene;
generating, by at least one hardware processor, a first summary of at least one dialogue of the at least one video scene; and
outputting, by the at least one hardware processor, a first result, the first result obtained by processing the first summary, the question and possible answers to the question.

11. The method of claim 10, wherein the processing is performed using a transformer.

12. The method of claim 10, wherein the first result is a score for each possible answer or the possible answer with the highest score.

13. The method of claim 10, further comprising:
generating, by the at least one hardware processor, a second summary of information related to the at least one video scene;
processing, by the at least one hardware processor, the second summary, the question and the possible answers to the question to obtain a second result; and
outputting, by the at least one hardware processor, a final result obtained by processing the first result and the second result.

14. The method of claim 13, wherein the at least one hardware processor is configured to process the first result and the second result using a fusion mechanism.

15. The method of claim 14, wherein the fusion mechanism is a modality attention mechanism that weights the first result and the second result.

16. A non-transitory computer-readable storage medium storing instructions that, when executed, cause at least one hardware processor perform the method of claim 10.
